(19) United States
(12) Patent Application Publication
(10) Pub. No.: US 2006/0032891 A1
(43) Pub. Date: Feb. 16, 2006

(54) Solid state processing of materials through friction stir processing and friction stir mixing

(76) Inventors: Richard A. Flak, Provo, UT (US); Scott M. Packer, Alpine, UT (US); Russell J. Steel, Salem, UT (US); Monte E. Russell, Orem, UT (US); Brian E. Taylor, Draper, UT (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 11/090,910

(22) Filed: Mar. 24, 2005

Related U.S. Application Data
(60) Provisional application No. 60/556,050, filed on Mar. 24, 2004.
(60) Provisional application No. 60/573,707, filed on May 21, 2004.
(60) Provisional application No. 60/637,223, filed on Dec. 17, 2004.
(60) Provisional application No. 60/652,808, filed on Feb. 14, 2005.

(51) Int. Cl. B23K 20/12; B23K 31/02; B23K 37/00

(52) U.S. Cl. 228/112.1; 228/2.1

(57) ABSTRACT

Solid state processing is performed on a workpiece by using a tool capable of friction stir processing, friction stir mixing, or friction stir welding, wherein solid state processing modifies characteristics of a workpiece while substantially maintaining a solid phase in some embodiments, allowing some elements to pass through a liquid phase in other embodiments, and wherein modified characteristics of the material include, but are not limited to, microstructure, macrostructure, toughness, hardness, grain boundaries, grain size, the distribution of phases, ductility, superplasticity, change in nucleation site densities, compressibility, expandability, coefficient of friction, abrasion resistance, corrosion resistance, fatigue resistance, magnetic properties, strength, radiation absorption, and thermal conductivity.

### Cross Reference to Related Applications

This document claims priority to and incorporates by reference all of the subject matter included in the provisional patent applications having docket number 2992.SMII.PR with Ser. No. 60/556,050 and filed Mar. 24, 2004, docket number 3043.SMII.PR with Ser. No. 60/573,707 and filed May 21, 2004, docket number 3208.SMII.PR with Ser. No. 60/637,223 and filed Dec. 17, 2004, and docket number 3213.SMII.PR with Ser. No. 60/652,808 and filed Feb. 14, 2005.

### BACKGROUND OF THE INVENTION

1. Field Of the Invention

This invention relates generally to solid state processing of materials through friction stir processing and friction stir mixing.

2. Background of the Problems Being Solved

Friction stir welding (hereinafter “FSW”) is a technology that has been developed for welding metals and metal alloys. The FSW process often involves engaging the material of two adjoining workpieces on either side of a joint by a rotating stir pin or spindle. Force is exerted to urge the spindle and the workpieces together and frictional heating caused by the interaction between the spindle and the workpieces results in plasticization of the material on either side of the joint. The spindle is traversed along the joint, plasticizing material as it advances, and the plasticized material left in the wake of the advancing spindle cools to form a weld.

FIG. 1 is a perspective view of a tool being used for friction stir welding that is characterized by a generally cylindrical tool 10 having a shoulder 12 and a pin 14 extending outward from the shoulder. The pin 14 is rotated against a workpiece 16 until sufficient heat is generated, at which point the pin of the tool is plunged into the plasticized workpiece material. The workpiece 16 is often two sheets or plates of material that are butted together at a joint line 18. The pin 14 is plunged into the workpiece 16 at the joint line 18. Although this tool has been disclosed in the prior art, it will be explained that the tool can be used for a new purpose. It is also noted that the terms “workpiece” and “base material” will be used interchangeably throughout this document.

The frictional heat caused by rotational motion of the pin 14 against the workpiece material 16 causes the workpiece material to soften without reaching a melting point. The tool 10 is moved transversely along the joint line 18, thereby creating a weld as the plasticized material flows around the pin from a leading edge to a trailing edge. The result is a solid phase bond 20 at the joint line 18 that may be generally indistinguishable from the workpiece material 16 itself, in comparison to other welds.

It is observed that when the shoulder 12 contacts the surface of the workpieces, its rotation creates additional frictional heat that plasticizes a larger cylindrical column of material around the inserted pin 14. The shoulder 12 provides a forging force that contains the upward metal flow caused by the tool pin 14.

During FSW, the area to be welded and the tool are moved relative to each other such that the tool traverses a desired length of the weld joint. The rotating FSW tool provides a continual hot working action, plasticizing metal within a narrow zone as it moves transversely along the base metal, while transporting metal from the leading face of the pin to its trailing edge. As the weld zone cools, there is typically no solidification as no liquid is created as the tool passes. It is often the case, but not always, that the resulting weld is a defect-free, recrystallized, fine grain microstructure formed in the area of the weld.

Travel speeds are typically 10 to 500 mm/min with rotation rates of 200 to 2000 rpm. Temperatures reached are usually close to, but below, solidus temperatures. Friction stir welding parameters are a function of a material's thermal properties, high temperature flow stress and penetration depth.

Friction stir welding has several advantages over fusion welding because 1) there is no filler metal, 2) the process can be fully automated requiring a relatively low operator skill level, 3) the energy input is efficient as all heating occurs at the tool/workpiece interface, 4) minimum post-weld inspection is required due to the solid state nature and extreme repeatability of FSW, 5) FSW is tolerant to interface gaps and as such little pre-weld preparation is required, 6) there is no weld spatter to remove, 7) the post-weld surface finish can be exceptionally smooth with very little to no flash, 8) there is no porosity and oxygen contamination, 9) there is little or no distortion or surrounding material, 10) no operator protection is required as there are no harmful emissions, and 11) weld properties are improved.

Previous patent documents have taught the benefits of being able to perform friction stir welding with materials that were previously considered to be functionally unweldable. Some of these materials are non-fusion weldable, or just difficult to weld at all. These materials include, for example, metal matrix composites, ferrous alloys such as steel and stainless steel, and non-ferrous materials. Another class of materials that were also able to take advantage of friction stir welding is the superalloys. Superalloys can be materials having a higher melting temperature bronze or aluminum, and may have other elements mixed in as well. Some examples of superalloys are nickel, iron-nickel, and cobalt-based alloys generally used at temperatures above 1000 degrees F. Additional elements commonly found in superalloys include, but are not limited to, chromium, molybdenum, tungsten, aluminum, titanium, niobium, tantalum, and rhenium.

It is noted that titanium is also a desirable material to friction stir weld. Titanium is a non-ferrous material, but has a higher melting point than other nonferrous materials.

The previous patents teach that a tool is needed that is formed using a material that has a higher melting temperature than the material being friction stir welded. In some embodiments, a superabrasive was used in the tool.

The embodiments of the present invention are generally concerned with these functionally unweldable materials, as well as the superalloys, and are hereinafter referred to as “high melting temperature” materials throughout this document.

It would be an advantage over the prior art to use the advantageous characteristics of friction stir welding and apply them to the new field of friction stir processing of high melting temperature materials.

Liquid State Processing of Materials

The periodic table outlines and organizes the elements that are used to engineer all of the materials developed and produced today. Each of these elements can exist in solid, liquid, or gaseous states depending on temperature and pressure. Solid materials created from these elements such as metallic ferrous alloys, metallic nonferrous alloys, metal matrix composites, intermetallics, cermets, cemented carbides, polymers, and others undergo specific processing to create the material's desired physical and mechanical properties.

Each of the previously named solid material types was created by mixing the elements together in some fashion and applying heat and/or pressure so that a liquid and/or liquid-solid mixture is formed. The mixture is then cooled to form the resulting solid material. The solid material formed will have a characteristic microscopic crystalline or granular structure that reveals some of the processing characteristics, phases of element mixtures, grain orientation, etc. For example, mild steel is made by mixing specified amounts of carbon and iron together (along with trace elements) and heating the mixture until a liquid is formed. As the liquid cools and solidifies, steel is formed.

Cooling rates, subsequent heat treatments and mechanical processing will affect the microstructure of the steel and its resulting properties. The microstructure reveals a granular structure having an average specific grain size and shape. Many decades of research and engineering have been dedicated to understanding and creating different materials from a variety of elements using temperature and mechanical processing to create desired material and mechanical properties.

Engineered materials such as metallic ferrous alloys, metallic nonferrous alloys, metal matrix composites, intermetallics, cermets, cemented carbides and others all require a process that melts some or all of the elements together to form a solid. However, there are several problems that occur as a result of having this liquid to solid phase transformation.

For example, during the liquid phase, the time at temperature and/or pressure often becomes a critical variable. Some elements dissolve into submixtures while others precipitate out as they are combined with other elements to form new phases. This dynamic behavior is a complex interaction of elemental solubility, diffusion characteristics, and thermodynamic behavior. Because of these complexities, it is difficult to engineer a material from the beginning. The material is instead developed through trial and error experimentation. Even when a specific elemental composition is determined, the liquid phase processing can have a multitude of process parameters that will alter the resulting solid material's properties. During this liquid phase, time, temperature and pressure play a critical role in determining the material's characteristics. The more elements combined in the mixture, the more difficult liquid phase processing becomes to produce a predictable material.

As the mixture solidifies, undesirable phases precipitate into the solid structure, detrimental dendritic structures can form, grain size gradients are created from temperature gradients, and residual stresses are induced which in turn cause distortions or undesirable characteristics in the resulting material. Solidification defects such as cracking and porosity are constant problems that plague the processing of materials formed from a prior liquid phase. All of these problems combine to lower a given material's mechanical and material properties. Unpredictability in a material's properties results in unpredictability in a component's reliability that is made from such materials.

Because of these solidification problems and resulting defects, additional mechanical and thermal processes are often performed in order to bring back some of the material's desirable properties. These processes include forging, hot rolling, cold rolling, and extrusion to name a few. Unfortunately, mechanical processes often give the material undesired directional properties, reduce ductility, add incremental residual stresses and increase cost. Heat treatments can be used to relieve residual stresses, but even these treatments can cause grains to grow and other distortions to occur.

It is often the case that the bulk size of materials being processed prohibits shorter processing times needed to prevent grain growth. The thermal capacitance of these large bulk materials also maintains elevated temperatures for extended periods of time which by itself also creates an environment for detrimental prolific grain growth. Unfortunately, quickly dropping the temperature of the bulk material through quenching is again problematic because cracking and residual stresses that approach the tensile strength of the material can be formed.

Thus it should be apparent why it is so difficult to design and produce a material with a given grain size, grain size distribution and elemental composition that has a desired range of properties when it is necessary to use a liquid phase mixture to create the solid material.

Manufacturers of many materials desire to produce very fine grain (sub-micron) microstructures to obtain the highest possible material and mechanical properties possible. Presently, fine grain microstructures are achieved with the addition of grain growth inhibiting elements or mixtures to the liquid phase of the processing. While reducing grain size, these inhibitors often cause other material processing problems. Some of these problems include lower strength of the material, grain boundary defects, and detrimental phases. Accordingly, what is needed is a system and method of processing that will create a material that is bonded together in the solid state with the lowest amount of heat input possible. In other words, what is needed is a system and method of processing that will create a material through a process that does not use a liquid phase.

High Temperature Friction Stir Welding Tool

In conjunction with the problems associated with the creation of materials that require liquid to solid phase transformation, recent advancements in friction stir welding (FSW) technologies has resulted in tools that can be used to join high melting temperature materials such as steel and stainless steel together during the solid state joining processes of friction stir welding.

As explained previously, this technology involves using a special friction stir welding tool. FIG. 2 shows a polycrystalline cubic boron nitride (PCBN) tip 30, a locking collar 32, a thermocouple set screw 34 to prevent movement, and a shank 36.

When this tool is used it is effective at friction stir welding of various materials. This tool design is also effective when using a variety of tool tip materials besides PCBN and PCD (polycrystalline diamond). Some of these materials include refractories such as tungsten, rhenium, iridium, titanium, molybdenum, etc.

Because these tip materials are often expensive to produce, a design having a replaceable tip is an economical way of producing and providing tools to the market because they can be replaced when worn or fractured.

### BRIEF SUMMARY OF THE INVENTION

It is one aspect of the present invention to provide a system and method for friction stir processing of a material in order to obtain beneficial microstructures.

It is another aspect to provide a system and method for friction stir processing in order to obtain beneficial macrostructures.

It is another aspect to provide a system and method for friction stir processing to improve toughness of a workpiece.

It is another aspect to provide a system and method for friction stir processing to increase or decrease hardness of a workpiece.

It is another aspect to provide a system and method for friction stir processing to modify targeted areas of a workpiece.

It is another aspect to provide a system and method for friction stir processing to modify a workpiece such that different areas of the same workpiece are modified to have different properties.

It is another aspect to provide a system and method for friction stir processing to modify the surface of a workpiece.

It is another aspect to provide a system and method for friction stir processing to modify the surface and at least a portion of the interior of the workpiece.

It is another aspect to provide a system and method for friction stir processing that only modifies portions of a workpiece while leaving other portions that are not modified.

In various embodiments of the present invention, solid state processing is performed on a workpiece by using a tool capable of friction stir processing, friction stir mixing, or friction stir welding, wherein solid state processing modifies characteristics of a workpiece while substantially maintaining a solid phase in some embodiments, allowing some elements to pass through a liquid phase in other embodiments, and wherein modified characteristics of the material include, but are not limited to, microstructure, macrostructure, toughness, hardness, grain boundaries, grain size, the distribution of phases, ductility, superplasticity, change in nucleation site densities, compressibility, expandability, coefficient of friction, abrasion resistance, corrosion resistance, fatigue resistance, magnetic properties, strength, radiation absorption, and thermal conductivity.

These and other aspects, features, advantages of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective view of a tool as taught in the prior art for friction stir welding, wherein the tool can be used to perform a new function.

FIG. 2 is a perspective view of a removable polycrystalline cubic boron nitride (PCBN) tip, a locking collar and a shank.

FIG. 3 is one embodiment of a friction stir processing tool having a shoulder and shank of equal diameter.

FIG. 4 is another embodiment of a friction stir processing tool having a shoulder and shank of different diameter.

FIG. 5 is a cross-sectional view of a base material that is friction stir processed to modify the characteristics of the base material.

FIG. 6 is a view of the microstructure of the base material before friction stir processing.

FIG. 7 is a view of the microstructure of the base material after friction stir processing.

FIG. 8 is a cross-sectional view of a base material that is friction stir processed to modify the characteristics of the base material, and having an overlay identifying where a cutting edge could be formed from the friction stir processed material.

FIG. 9 is an illustration of the microstructure that shows large grain size of the annealed condition of the material.

FIG. 10 is a cross-sectional view of material that has been friction stir mixed so as to include another material.

FIG. 11 is a cross-sectional view of the microstructure of the steel of FIG. 10.

FIG. 12 is a cross-sectional view of one embodiment for friction stir mixing an additive material 112 into another using a mesh or screen 110 to hold the additive material 112 in place.

FIG. 13 is a cross-sectional illustration of the results of friction stir mixing tungsten carbide in the form of a powder into steel.

FIG. 14 is a planar view of the microstructure of the surface of the region where the steel 120 and the tungsten carbide power are mixed.

### DETAILED DESCRIPTION OF THE INVENTION

Reference will now be made to the drawings in which the various elements of embodiments of the present invention will be given numerical designations and in which the invention will be discussed so as to enable one skilled in the art to make and use the embodiments. It is to be understood that the following description is only exemplary of the principles of the present invention, and should not be viewed as narrowing the claims which follow.

The present invention as explained hereinafter will apply to several different classes of materials. In one embodiment, the materials may be considered to be those materials that have melting temperatures higher than bronze and aluminum as previously disclosed. This class of materials includes, but is not limited to, metal matrix composites, ferrous alloys such as steel and stainless steel, non-ferrous materials, superalloys, titanium, cobalt alloys typically used for hard-facing, and air hardened or high speed steels. In another embodiment, the materials may be considered to be all other lower melting temperature materials that are not included within the definition of the higher melting temperatures described above.

Solid State Processing

In a first embodiment of the present invention, a solid state processing and a solid state joining method have been developed to yield improved material and mechanical properties for new and existing materials. It is noted that processing and joining may be exclusive events of each other, or they may take place simultaneously. It is also noted that solid state processing may also be referred to interchangeably with the phrase “friction stir processing.” Solid state processing is defined herein as a temporary transformation into a plasticized state that typically does not include a liquid phase. However, it is noted that some embodiments allow one or more elements to pass through a liquid phase, and still obtain the benefits of the present invention.

The benefits of solid state joining became apparent with the development of friction stir welding (FSW) when two or more materials were joined together. It was noted earlier that travel speeds of the friction stir welding tool are typically 10 to 500 mm/min with rotation rates of 200 to 2000 rpm. It is noted, however, that travel speeds and rotation rates can be varied in some embodiments of the present invention. For example, the diameter of the tool can be modified such that travel speeds and rotation rates may be increased or decreased.

In the present invention, the basics of this technology are applied to materials on a microscopic scale so that processing of solids in a variety of forms can be achieved. This method can be used to synthesize new or existing materials using both low melting temperature and high melting temperature materials.

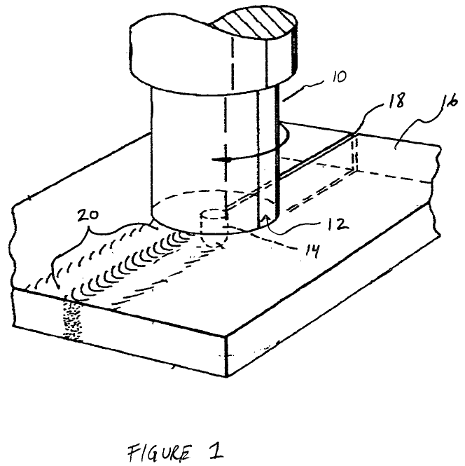

A first aspect of the present invention is the tool that is used to perform friction stir processing. Friction stir processing can be performed using the tool shown in FIG. 1. Thus, a friction stir processing tool can have a shank, a shoulder, and a pin. In one embodiment, the tool pin is rotated and plunged into the material to be processed. The tool is moved transversely across a processing area of the material. It is the act of causing the material to undergo plasticization in a solid state process that can result in the material being modified to have properties that are different from the original material.

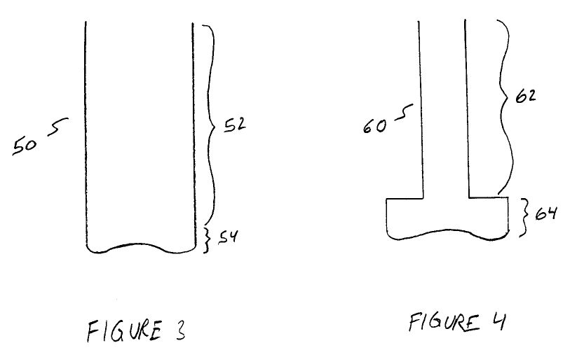

Another embodiment of the present invention is to use a tool as shown in FIG. 3. FIG. 3 is a cross-sectional view of a cylindrical friction stir processing tool 50. The friction stir processing tool 50 has a shank 52 and a shoulder 54, but no pin. Therefore, instead of plunging a pin into the material to be solid state processed, the shoulder is pressed against the material. Penetration by the shoulder is typically going to be restricted to the surface of the material or just below it because of the larger surface area of the shoulder as compared to the pin.

It should be noted that while the pin 14 of the tool 10 in FIG. 1 does not have to be plunged into the material, the pin may be designed for easy penetration. Thus, because the pin 14 is more likely to have a very small surface area as compared to the tool 50 of FIG. 3, the pin is more likely to plunge into the material. However, it may be advantageous to use the smaller surface area of the pin 14 for processing much smaller areas of a material, even just on the surface thereof. Therefore, it is another embodiment of the present invention that surface and near-surface processing can also be accomplished using a tool that is more typically used for penetration and joining of materials.

FIG. 4 is provided as an alternative embodiment for a tool having no pin. FIG. 4 shows a tool 60 having a shank 62 that is smaller in diameter than the shoulder 64. This design can be more economical, depending upon the scale of the diameter of the shoulder 64.

It is important to recognize that nothing should be inferred from the shape of the shoulders 54 and 64 in FIGS. 3 and 4. The shoulders 54 and 64 are shown for illustration purposes only, and their exact cross-sectional shapes can be modified to achieve specific results.

Experimental results have demonstrated that the material being processed may undergo several important changes during friction stir processing. These changes include, but should not be considered limited to, the following: toughness, hardness, grain boundaries, grain size, distribution of phases, ductility, superplasticity, change in nucleation site densities, compressibility, expandability, friction, and thermal conductivity.

Regarding nucleation, observations indicate that there may be more nucleation sites due to the energy induced into the material from the heat and deformation generated during friction stir processing. Accordingly, more of the solute material may be able to come out of solution or precipitate to form higher densities of precipitates or second phases.

As an example, consider the following figures that illustrate cross-sections of a material that has undergone friction stir processing through the plunging of a tool into the material. While observing the figures, it should be understood that similar or identical results can be obtained on smaller scales if the tool is not plunged into the material being processed.

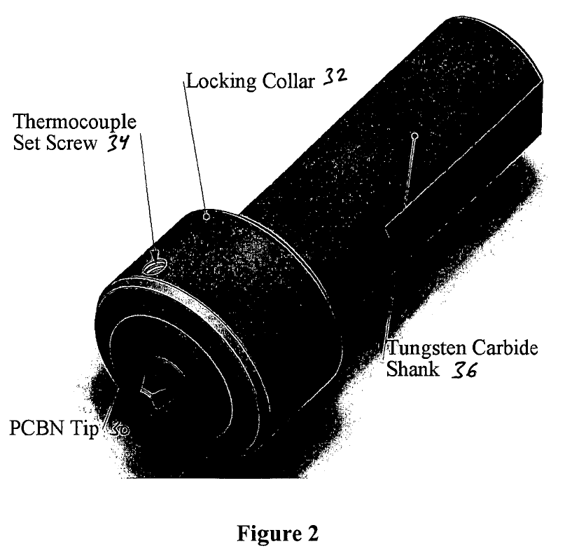

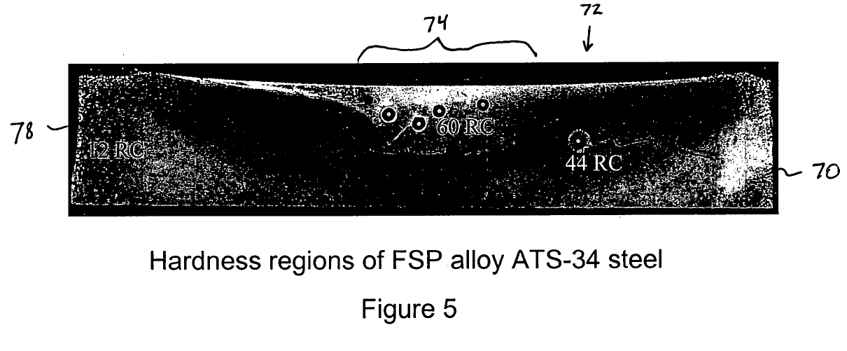

In FIG. 5, a section of ATS 34 steel was friction stir processed by plunging a tool similar to the tool shown in FIG. 2 into the base material 70 and moving the tool transversely along a middle length thereof. Transverse movement would be perpendicular to the page, thus FIG. 5 is a cross-sectional view of the base material 70.

FIG. 5 shows that the tool plunged into the base material 70 from the top 72. Several areas appearing as small circles are shown as having been tested for hardness relative to the Rockwell scale in the various zones of the base material. The stir zone 74 is shown having a hardness of 60 RC. Close to the boundary of the inner TMAZ (thermally mechanically affected zone) and the outer HAZ (heat affected zone) the base material 70 is shown as having a hardness value of 44 RC at a location 76. Finally, an unprocessed or original base material zone is shown as having retained, in other samples, its original hardness value of 12 RC at approximately location 78.

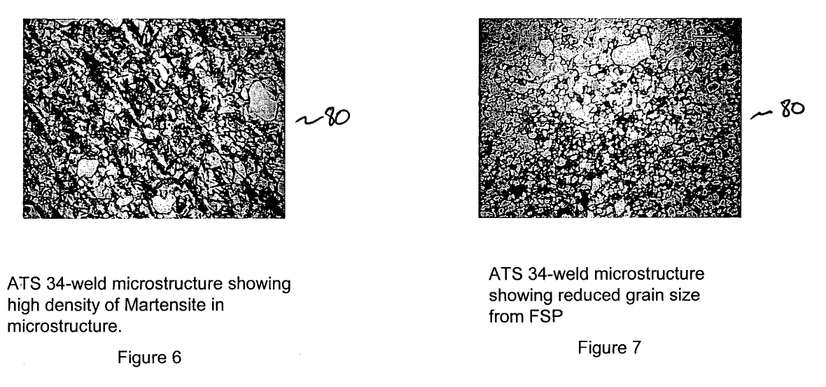

FIG. 6 is provided to illustrate the microstructure of a processed base material 80. The figure shows that friction stir processing has created Martensite indicating the harder phase of the processed base material 80.

Similarly, FIG. 7 is also an illustration of the microstructure of the material 80 after it has been friction stir processed. The figure shows the reduced grain size in the processed base material 80.

For purposes of comparison, heat treatment of the base material 70 of FIG. 5 would typically result in a hardness value less than 60 RC. In some embodiments of the present invention, it is possible to selectively friction stir process large portions of the base material 70 that are otherwise difficult to do with other heat treatment methods. In addition, a material designer can be more selective in the areas of the material that are to receive processing. Furthermore, although heat treatment will alter the microstructure of the material, the changes will not be the same type of changes that can be achieved with friction stir processing. For example, the processed area has also experienced a substantial increase in toughness. This is notable because there is typically a tradeoff between toughness and hardness when processing materials using conventional treatment techniques.

In another embodiment, a member formed of D2 steel was friction stir processed along one edge thereof. After processing the edge, the hardness across the width of the member from an interior unprocessed region to the processed region was determined. The hardness gradient in the material result from the friction stir processing is illustrated in Graph 1. In this example, the friction stir processing resulted in a significant improvement in the hardness characteristics of the material in the friction stir zone along with an improvement in toughness.

[image]

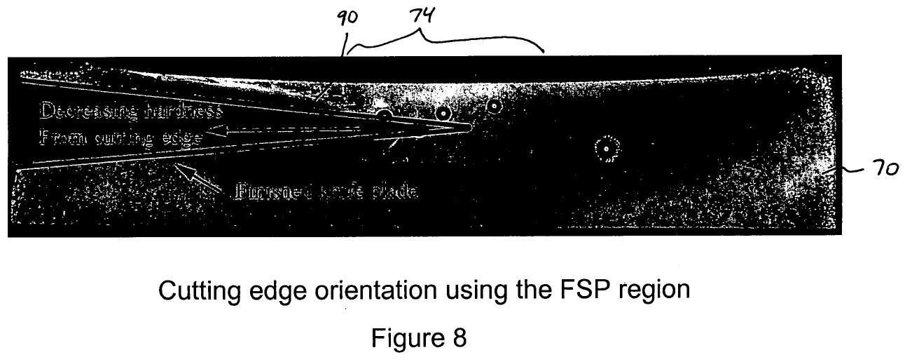

FIG. 8 is an illustration of an overlay 90 of a cutting edge on the ATS-34 steel base material 70. The overlay 90 indicates one advantageous configuration of a cutting edge that could be machined from the material 70, wherein the configuration takes the greatest advantage of the improved toughness and hardness characteristics of the friction stir processed material 70. Note that the cutting edge overlay 90 is formed in the processed region 74 that will result in a hard and yet tough cutting edge. Likewise, any object being formed from a processed material can be arranged to provide the most advantageous properties where it is most critical for the object. In this example, a beneficial cutting edge will be achieved from having an edge disposed well within the processed material.

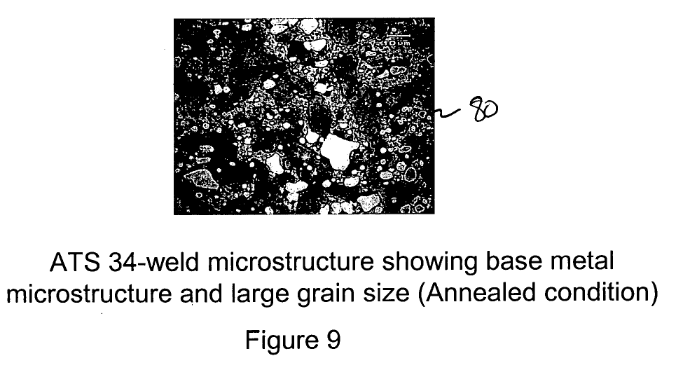

FIG. 9 is helpful for making comparisons between the microstructure of the processed base material 80 of FIGS. 6 and 7, and the unprocessed base material 80 shown here. The microstructure shows the large grain size of the annealed condition of the base material 80 before friction stir processing.

FIGS. 5 though 8 have illustrated the aspect of the present invention regarding friction stir processing. In this case, the term “processing” is being used when a single material is being processed alone as taught by the present invention. The term of “processing” can likewise be applied to the case where at least two materials are being mixed together. However, for the sake of clarity, this concept of mixing at least two materials will be referred to as “friction stir mixing”.

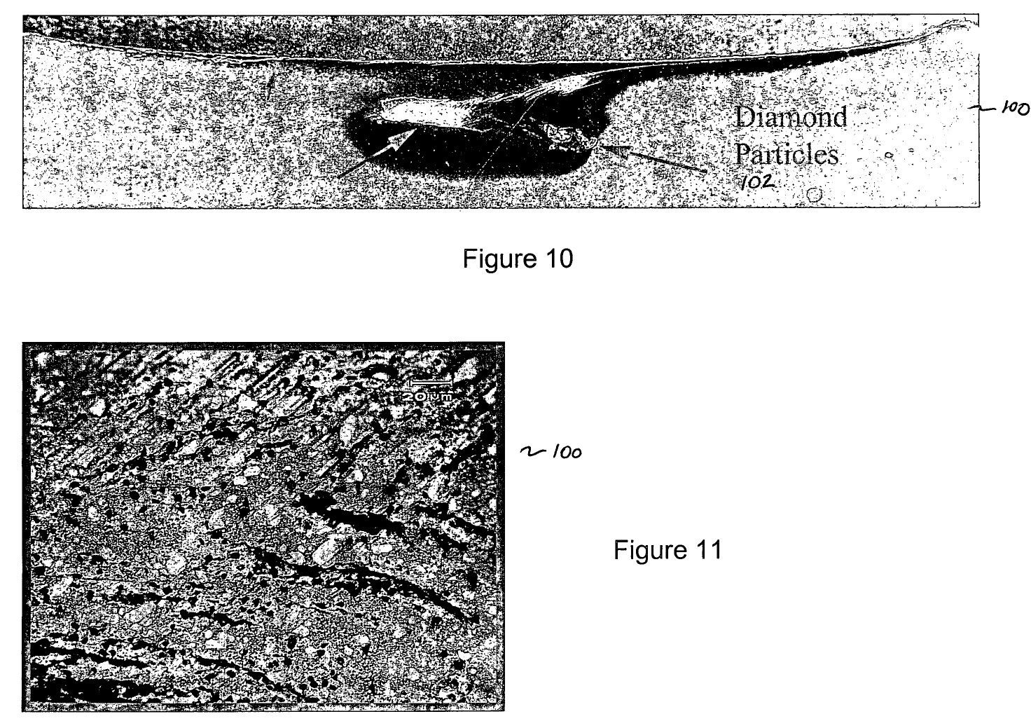

FIG. 10 is a cross-sectional view of a base material that has been friction stir mixed so as to include another additive material. Specifically, a steel member 100 has been friction stir mixed so as to work in diamond particles 102 into the steel member.

FIG. 11 is a cross-sectional view of the microstructure of the steel member 100. The figure shows that the diamond particles 102 are present throughout the mixed region of the steel member 100.

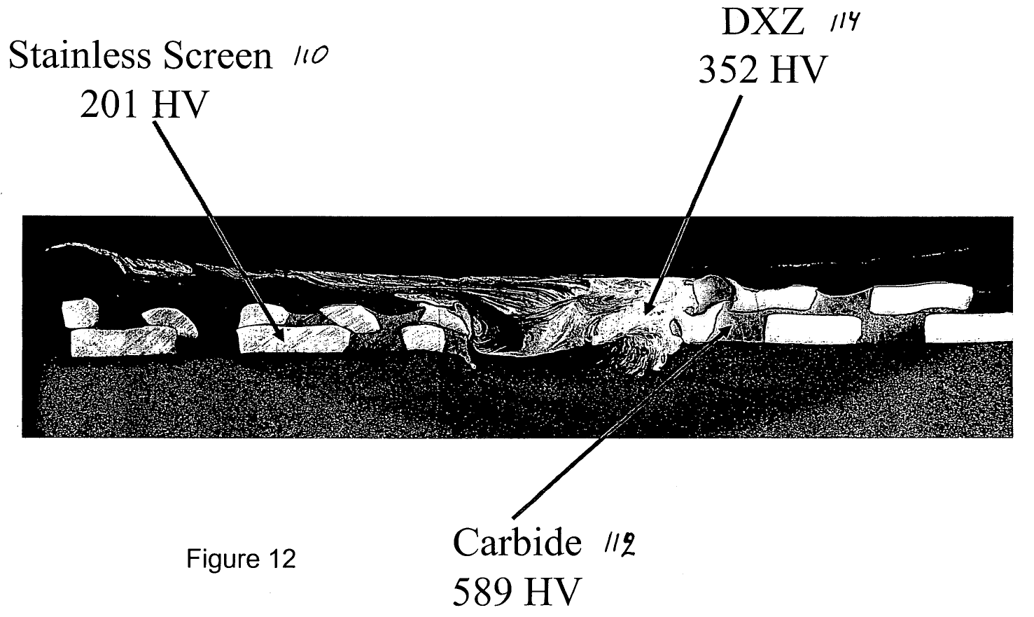

FIG. 12 is a cross-sectional view of one embodiment for friction stir mixing an additive material 112 into another using a mesh or screen 110 to hold the additive material 112 in place. Specifically, a stainless steel mesh or screen 110 is being used to hold carbide 112 in the form of a powder. The screen 110 and carbide powder 112 are disposed on the surface of a base material 114. The surface of the base material 114 is then friction stir processed, resulting in a mixing of the stainless steel 110, the carbide 112, and the base material 114 at the surface of the base material. Alternatively, the different materials could be mixed further into the base material 114 using a tool having a pin, or by using a tool having a shoulder that is pressed harder into the base material.

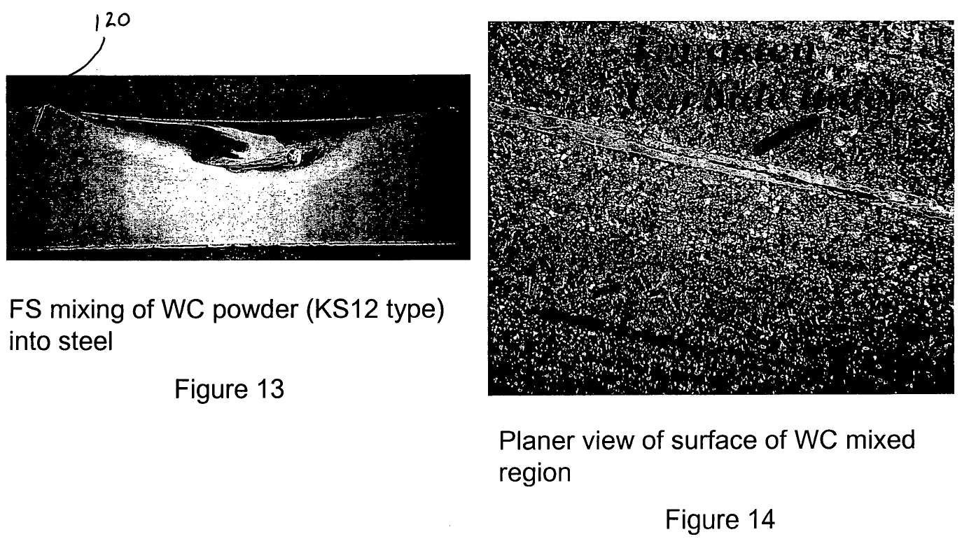

FIG. 13 is a cross-sectional illustration of the results of friction stir mixing tungsten carbide in the form of a powder into steel member 120.

FIG. 14 is a planar view of the microstructure of the surface of the region where the steel member 120 and the tungsten carbide power are mixed.

Another aspect of the present invention is the ability to both solid state process and join at the same time. Consider two workpieces being welded together. The workpieces could be the same material or different materials. By friction stir welding the workpieces together, the resulting material can have distinctly different properties in a weld region from those of the materials that are being joined together.

As shown in FIG. 12, the embodiment shows that it is possible to introduce another material into a base material for friction stir mixing. However, the present invention should not be considered to be limited to this one design. Some other methods of introducing an additive material include, but are not limited to, entrenching a packed powder into the surface of a workpiece, sandwiching a material between workpieces to be joined together, and even using adhesives to bind the additive to the workpiece until friction stir mixed together. The adhesive can be selected so that it burns away during the friction stir mixing process, thereby not affecting the resulting mixed materials. However, it should be realized that it may be desirable to include whatever material is being used to bind an additive to a base material.

Another method of introducing an additive is through the use of a consumable tool. For example, a pin may be comprised of a material that will erode away into the base material. Thus, the pin is comprised of the additive material.

The present invention can also be considered as a new means for introducing energy into materials processing. Essentially, mechanical energy is being used in a solid state process to modify a material. The mechanical energy is in the form of the heat and deformation generated by the action of friction stir processing or friction stir mixing.

Another aspect of the present invention is the ability to modify and control residual surface and subsurface stress components in a processed material. In some embodiments, it is possible to introduce or increase compression stress, while in other embodiments, undesirable stresses may be reduced.

Controlling residual stresses may be particularly important in some high melting temperature materials. Friction stir processing and friction stir mixing includes contacting a workpiece with a rotating (or otherwise moving) friction stir processing or friction stir mixing tool to thereby generate a solid state processing of the material to modify stress along a surface of the material. Stress reduction should not be considered to be limited only to the surface. In other embodiments, the aspect of modifying subsurface stress is also a part of the present invention.

Some embodiments also enable a user to control heating and cooling rates by exercising control over process parameters. Friction stir processing and mixing parameters include relative motion of the tool (e.g., rotation rate and translational movement rate of the tool), depth of tool penetration, the downward force being applied to the tool, cooling rates along with cooling media (water cooling), etc.

Regarding friction stir mixing, the nature of the additive material can also directly influence the nature of the resulting processed area. Powder and diamond particles were discussed above. In an alternative embodiment, the physical structure of the additive material may affect the resulting properties. For example, fibers or other types of elongated particles can be mixed into a base material in a zone inside as well as just outside of a mixing region. In addition, additive materials can be harder or softer than the base material or other additives.

All additive materials may be selected so as to control mechanical properties such as abrasion resistance, corrosion resistance, hardness, toughness, crack prevention, fatigue resistance, magnetic properties, and hydrogen embrittlement, among others, of the base material. For example, the hard particles will be held in place mechanically, or by solid state diffusion, with greater retention than cast structures since the strength of the mixing region may or may not be greater than in the base material.

Hard particles may include tungsten carbide, silicon carbide, aluminum oxide, cubic boron nitride, and/or diamond or any material harder than the base material that will not go fully into solution at the mixing temperature (usually 100 to 200 degrees C. below the melting point of the base material). In addition, fibers may be added in the same fashion to locally strengthen the base material or add directional properties.

Additive materials may be specifically selected for the ability to go into solution in order to achieve some specific characteristic of the processed base material. Additives can also enhance toughness, hardness, enhance thermal characteristics, etc.

Another advantage of putting additives into a base material is that particles or fibers can be selected from materials that cannot be used in fusion or hard facing processing because they would go into solution during a liquid phase of the base material. In friction stir processing, eutectic compositions of the particle/fiber with the base material can be avoided so that dual properties can be achieved. The introduction of the particle/fiber into the base material can be varied to tailor different properties within a given workpiece.

For example, a tool with a long pin can be used to stir particles/fibers to a deeper depth and then a second tool with a shorter pin can be used to stir a different particle/fiber at a different depth to form layered features in the base material. Geometry of a mixing region, particle/fiber composition, particle/fiber size, particle/fiber distribution and location within the base material can provide engineered wear and strength features to a given object.

A friction stir processing tool similar to the tool shown in FIG. 2 can be used to create new materials and modify existing materials. For example, elements in powder form can be placed in a mold. The tool 10 can be rotated and plunged into the powder to generate heat. As the tool 10 is traversed through the powder, solid state diffusion occurs to join the powder into a solid form with the base material. Likewise, a groove can be cut in a material and filled with powder having a mixture of elements and then friction stir processed to mix the materials together.

Alternatively, material can be added directly to the surface of the material, or it can be sandwiched between two pieces of material such as steel, and then friction stir processed to join the materials together. Other methods can also be used to accomplish mixing of materials together in friction stir mixing.

When friction stir mixed, the powder is mixed with the base material by friction stir mixing to form a material having modified properties in the stir region. In selected embodiments, the process creates little heat generation and has low energy input, requires a very short time at temperature, will generally have fewer solidification defects, and can be fully automated. Advantageously, one or more embodiments need minimum post-processing inspection due to the solid state nature and extreme repeatability of the processing.

The processing method is tolerant to interface gaps and as such little pre-processing preparation, there is no material spatter to remove. The post-processing surface finish can be exceptionally smooth in selected embodiments with very little to no flash. Unlike other processes, the friction stir processing performed in accordance with some embodiments of the present invention can be done with little porosity and oxygen contamination and little or no distortion. Furthermore, friction stir processing can be performed in a controlled gas or liquid environment.

Elements, alloys, metals, and or other material types can be processed in solid form, powder form, fiber form, plate form, as wire, or in a series of composite compositions. In some embodiments, new materials can now be designed without concern for liquid phase problems.

Table 1 below shows some examples of how material characteristics can be affected. It should be noted that by friction stir processing or friction stir mixing additives may occur that counteract desired material characteristics.

TABLE 1

| | Elements that exhibit strong |
|---|---|
| Characteristic | characteristic behavior |
| Electrical | Copper |
| Conductivity | |
| Abrasion Resistance | Carbides (W, Si, etc . . .) Diamond, CBN, |
| | Nitrides, Oxides |
| Strength | Cobalt, Nickel, Martensitic formations in |
| | steel structures |
| Toughness | Nickel |
| Corrosion Resistance | Nickel, chrome, Molybdenum |
| High Thermal | Copper |
| Conductivity | |
| Low Thermal | Cobalt, Titanium |
| Conductivity | |
| Radiation Absorption | Silicon carbides, Boron carbides |

It is to be understood that the above-described arrangements and embodiments are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for modifying characteristics of a base material through friction stir processing, said method comprising the steps of:
1) providing a high melting temperature base material;
2) providing a friction stir processing tool that includes a higher melting temperature material than the base material on a portion thereof; and
3) friction stir processing the base material to thereby modify at least one characteristic thereof.

2. The method as defined in claim 1 wherein the method further comprises the step of causing a substantially solid state transformation without passing though a liquid state of the base material.

3. The method as defined in claim 1 wherein the step of providing the high melting temperature base material includes selecting the high melting temperature base material from the group of high melting temperature materials including ferrous alloys, non-ferrous materials, superalloys, titanium, cobalt alloys typically used for hard-facing, and air hardened or high speed steels.

4. The method as defined in claim 1 wherein the method further comprises the step of synthesizing a new material having at least one different characteristic from the base material.

5. The method as defined in claim 1 wherein the method further comprises the steps of:
1) providing an additive material; and
2) friction stir mixing an additive material into the base material to thereby modify at least one characteristic of the base material.

6. The method as defined in claim 1 wherein the method further comprises the step of modifying a microstructure of the base material.

7. The method as defined in claim 6 wherein the method further comprises the step of modifying a macrostructure of the base material.

8. The method as defined in claim 7 wherein the step of modifying the microstructure includes increasing toughness of the base material.

9. The method as defined in claim 7 wherein the step of modifying the microstructure includes increasing or decreasing hardness of the base material.

10. The method as defined in claim 7 wherein the step of modifying the microstructure includes modifying grain boundaries of the base material.

11. The method as defined in claim 7 wherein the step of modifying the microstructure includes decreasing grain size of the base material.

12. The method as defined in claim 7 wherein the step of modifying the microstructure includes modifying distribution of phases of the base material.

13. The method as defined in claim 7 wherein the step of modifying the microstructure includes modifying ductility of the base material.

14. The method as defined in claim 7 wherein the step of modifying the microstructure includes modifying superplasticity of the base material.

15. The method as defined in claim 7 wherein the step of modifying the microstructure includes increasing nucleation site densities of the base material.

16. The method as defined in claim 7 wherein the step of modifying the microstructure includes modifying compressibility of the base material.

17. The method as defined in claim 7 wherein the step of modifying the microstructure includes modifying ductility of the base material.

18. The method as defined in claim 7 wherein the step of modifying the microstructure includes modifying the coefficient of friction of the base material.

19. The method as defined in claim 7 wherein the step of modifying the microstructure includes increasing or decreasing thermal conductivity.

20. The method as defined in claim 7 wherein the step of modifying the microstructure includes increasing abrasion resistance.

21. The method as defined in claim 7 wherein the step of modifying the microstructure includes increasing corrosion resistance.

22. The method as defined in claim 7 wherein the step of modifying the microstructure includes modifying magnetic properties.

23. The method as defined in claim 1 wherein the method further comprises the step of only modifying specific areas of the base material.

24. The method as defined in claim 1 wherein the method further comprises the step of modifying the base material so as to have at least two friction stir processed areas, wherein the at least two friction stir processed areas have at least one characteristic that is different from each other.

25. The method as defined in claim 1 wherein the method further comprises the step of only friction stir processing generally on or near the surface of the base material.

26. The method as defined in claim 1 wherein the method further comprises the step of friction stir processing at least a portion of an interior of the base material.

27. The method as defined in claim 1 wherein the step of providing a friction stir processing tool that includes a higher melting temperature material than the base material includes using a superabrasive in the friction stir processing tool.

28. The method as defined in claim 1 wherein the method further comprises the step of selecting lower melting temperature materials that are difficult to weld including metal matrix composites.

29. The method as defined in claim 1 wherein the method further comprises the step of friction stir mixing base materials that are selected from the high melting temperature group and the lower melting temperature group to form a new material in a welding region.

30. The method as defined in claim 1 wherein the method further comprises the step of friction stir welding the base material to at least one other workpiece, wherein a welding region between the base material and the at least one other workpiece has characteristics that are different from the base material and the at least one other workpiece.

31. The method as defined in claim 1 wherein the step of providing the friction stir processing tool further includes the step of providing the friction stir processing tool having a shank, a shoulder and a pin.

32. The method as defined in claim 31 wherein the step of providing the friction stir processing tool having a shank, a shoulder and a pin further comprises the step of including a superabrasive material.

33. The method as defined in claim 32 wherein the method further comprises the step of friction stir processing without plunging the pin into the base material.

34. The method as defined in claim 1 wherein the step of providing the friction stir processing tool further includes the step of providing the friction stir processing tool having a shank and a shoulder.

35. The method as defined in claim 1 wherein the method further comprises the step of having a hardness gradient in the base material between a processed area and an unprocessed area of the base material.

36. The method as defined in claim 1 wherein the step of modifying the microstructure includes further includes introducing energy into the base material, to thereby modify characteristics of the processed base material.

37. The method as defined in claim 1 wherein the step of modifying the microstructure includes modifying residual stress components in the base material.

38. The method as defined in claim 38 wherein the step of modifying the microstructure includes modifying residual surfaces stresses in the base material.

39. The method as defined in claim 39 wherein the step of modifying the microstructure includes modifying residual sub-surfaces stresses in the base material.

40. The method as defined in claim 1 wherein the method further comprises the step of controlling heating and cooling rates of the base material during friction stir processing by controlling process parameters, and thereby controlling characteristics of the processed base material.

41. The method as defined in claim 40 wherein the method further comprises the step of selecting process parameters to control from the group of process parameters including rotation rate of the tool against the base material, translation movement rate of the tool along the base material, depth of tool penetration into the base material, force applied by the tool against the base material, and presence of a cooling medium.

42. The method as defined in claim 5 wherein the method further comprises the step of selecting properties of the additive material from the group of properties including hard particles, soft particles, elongated particles, and fibrous particles.

43. The method as defined in claim 5 wherein the method further comprises the step of selecting the additive material from additive materials that would otherwise go into solution if exposed to a liquid state of the base material.

44. The method as defined in claim 7 wherein the step of modifying the microstructure includes increasing or decreasing strength of the base material.

45. The method as defined in claim 7 wherein the step of modifying the microstructure includes increasing or decreasing radiation absorption of the base material.

46. A system for modifying characteristics of a base material through friction stir processing, said system comprised of:
a high melting temperature base material; and
a friction stir processing tool that includes a higher melting temperature material than the base material on a portion thereof, wherein the tool is used to perform friction stir processing to thereby cause solid state transformation of the base material, wherein characteristics of the base material are modified.

47. The system as defined in claim 46 wherein the tool is further comprised of a shank, a shoulder and a pin.

48. The system as defined in claim 46 wherein the tool is further comprised of a shank and a shoulder.

49. A method for modifying characteristics of a base material through friction stir processing, said method comprising the steps of:
1) providing a high melting temperature base material;
2) providing a friction stir processing tool that includes a higher melting temperature material than the base material on a portion thereof; and
3) moving the tool against the base material to thereby cause solid state transformation of the base material, wherein characteristics of the base material are modified.

50. The method as defined in claim 49 wherein the method further comprises the step of selecting movement of the superabrasive tool from the group of superabrasive tool movements including rotational motion and linear motion.
